(19) United States
(12) Patent Application Publication
(10) Pub. No.: US 2014/0130522 A1
(43) Pub. Date: May 15, 2014

(54) Liquefied Gas Supply Conditioning System and Method

(71) Applicant: CATERPILLAR INC., Peoria, IL (US)

(72) Inventors: Joshua W. Steffen, El Paso, IL (US); Alan R. Stockner, Metamora, IL (US)

(73) Assignee: CATERPILLAR INC., Peoria, IL (US)

(21) Appl. No.: 13/675,398

(22) Filed: Nov. 13, 2012

(51) Int. Cl. F17C 9/02

(52) U.S. Cl. CPC F17C 9/02
USPC 62/48.1

(57) ABSTRACT

A conditioning system for a liquefied gas includes a source of liquefied gas, the liquefied gas provided from the source at a first temperature. A first heater is disposed to heat a flow of the liquefied gas to a second temperature. An accumulator is disposed to collect and store a quantity of the liquefied gas at the second temperature. A second heater is disposed to receive a flow of gas from the accumulator and the first heater, the second heater operating to heat the gas to a third temperature and provide the heated gas at the third temperature to a gas outlet.

### TECHNICAL FIELD

This patent disclosure relates generally to liquefied gas conditioning systems and, more particularly, to a liquefied gas conditioning system for use as a fuel source for an internal combustion engine or in other technical and industrial applications.

### BACKGROUND

Use of liquefied gas as a fuel source for various applications has gained popularity in recent years due to the lower cost and cleaner burning of gaseous fuels such as liquefied petroleum gas (LPG), compressed natural gas (CNG), or liquefied natural gas (LNG), as compared to more traditional fuels such as gasoline or diesel. In practical applications, for example, mining trucks, locomotives, highway trucks and the like, to gain sufficient range between refueling, the gaseous fuel is stored and carried on-board the vehicle in a liquefied, pressurized, cryogenic state. Before the cryogenically stored fuel is to be used by the engine, it is heated to elevate its temperature from about −160 deg. C. to about 90 deg. C. Moreover, the gaseous fuel is pressurized for injection into the intake system or the engine cylinders to provide sufficient power density.

In a typical application, a certain amount of fuel is heated and pressurized to maintain a constant fuel supply to the engine. This heated and pressurized gaseous fuel is stored within a high-pressure reservoir that is also carried by the vehicle. The size of the vehicle determines the amount of fuel that may be stored therein, which in turn depends on the fuel requirements of the vehicle or machine onto which it is installed. For example, a mining truck may require an ample amount of fuel on hand that is ready for use when the load requirements on the engine increase, for example, when the truck is loaded and travels up an incline.

It is often the case that insufficient space exists on vehicles to carry a high-pressure cylinder that is large enough to accommodate a sufficient supply of heated fuel for use in the vehicle's engine. This issue is especially pronounced in vehicles that are retrofitted to operate on liquefied gas rather than a traditional fuel such as diesel because the design of the vehicle's powertrain and engine package does not account for a packaging space for a high-pressure gas cylinder. As can be appreciated, with gas pressures ranging at about 40 MPa, such gas cylinders can be substantial and will typically have a cylindrical shape, which exacerbates their placement onto an area of the vehicle that is both close to the engine as well as outside of the vehicle's crash envelope.

### SUMMARY

The disclosure describes, in one aspect, a conditioning system for a liquefied gas. The system includes a source of gas maintained in and provided to the system in a liquefied state at a first temperature. A first heater is disposed to heat a flow of the gas passing therethrough to a second temperature. An accumulator is disposed to collect and store a quantity of the gas at the second temperature. A second heater is disposed to receive a flow of gas from the accumulator and the first heater. The second heater operates to heat the gas to a third temperature and provide the heated gas at the third temperature to a gas outlet.

In another aspect, the disclosure describes a fuel system for an internal combustion engine associated with a vehicle. The fuel system includes a fuel tank for storing liquefied natural gas (LNG) in a cryogenic state at a first temperature. The fuel tank is disposed in the vehicle. A LNG pump draws LNG from the fuel tank and pressurizes the LNG to an operating pressure. A first-stage heater is disposed to receive LNG from the LNG pump as a fluid flow. The first-stage heater is configured to heat the fluid flow to a second temperature by use of heat provided from a first engine coolant flow circulating through the first-stage heater. An accumulator is disposed to receive at least a portion of the fluid flow from the first-stage heater, and to store the portion of the fluid flow therein. A second-stage heater is disposed to receive at least the remaining portion of the fluid flow from the first heater. The second-stage heater is configured to heat the fluid flow to a third temperature by use of heat provided from a second engine coolant flow circulating through the second-stage heater. The fluid flow at the third temperature is useable as a fuel supply and is provided to the internal combustion engine during operation.

In yet another aspect, the disclosure describes a method for conditioning a liquefied gaseous fuel for use in an internal combustion engine onboard a vehicle. The method includes storing the liquefied gaseous fuel at a first temperature in a cryogenic storage tank carried onboard the vehicle, drawing a flow of the liquefied gaseous fuel from the cryogenic storage tank, and compressing said flow to an operating pressure. The flow is provided to a first heater that is configured to heat the flow from the first temperature to a second temperature, where the second temperature is below an operating temperature at which gaseous fuel is provided to the internal combustion engine. At least a portion of the flow is stored at least temporarily in an accumulator. The portion of the flow that is stored at least temporarily is provided to the accumulator close to the second temperature. The flow is provided to a second heater that is configured to heat the flow to a third temperature, where the third temperature is about equal to the operating temperature. The flow at the third temperature is provided to operate the internal combustion engine.

### BRIEF DESCRIPTION OF THE DRAWINGS

FIG. 1 is a block diagram of a liquefied gas supply system in accordance with the disclosure.

FIG. 2 is a block diagram of an engine system using a liquefied gas supply system in accordance with the disclosure.

FIG. 3 is a block diagram for a controller in accordance with the disclosure.

FIG. 4 is a flowchart for a method of conditioning a liquefied gas in accordance with the disclosure.

### DETAILED DESCRIPTION

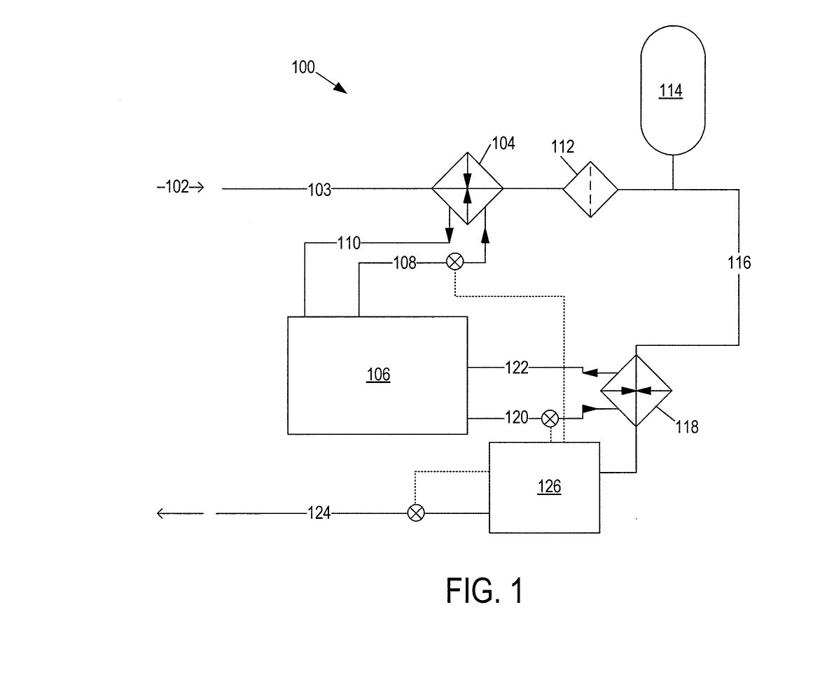

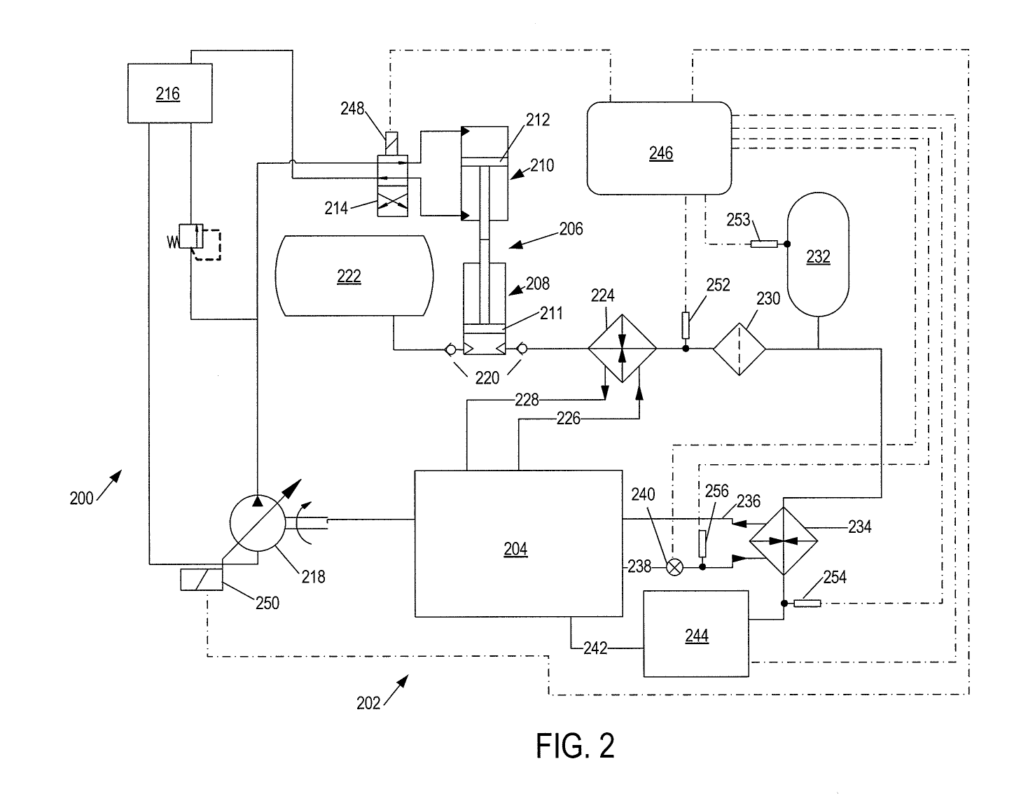

This disclosure relates to conditioning systems for converting a liquefied gas supply into a useable gas and, in one embodiment, to a conversion system for converting liquefied natural or petroleum gas drawn from a cryogenic storage tank in vehicles into a gas supply having temperature and pressure control for use as a fuel supply for a vehicle engine. The disclosure provides a general embodiment by way of the block diagram shown in FIG. 1 for a gas conditioning system that has general applicability to any liquefied gas system. FIG. 2 is a block diagram of a particular implementation of the gas conditioning system in a vehicle application for providing gaseous fuel to operate an engine.

In reference now to the block diagram of FIG. 1, a gas conditioning system 100 is shown. The gas conditioning system 100 includes an inlet 102 that is configured to receive a supply of compressed, liquefied gas. For example, the inlet 102 may be arranged to receive pressurized, liquefied oxygen, hydrogen, argon, helium, or other industrial gases for use in industrial applications. Such gases are typically stored in a cryogenic state in storage tanks and are conditioned on-demand when needed by the industrial processes using them.

A flow of pressurized, still liquefied gas at the inlet 102 is provided to a first-stage heat exchanger 104 via a supply conduit 103. The first-stage heat exchanger 104 may have a conventional construction and be arranged to transfer thermal energy from a heating fluid to the working fluid or gas passing through the supply conduit 103. In the illustrated embodiment, the heating fluid may be water or coolant provided through a heat source 106 by way of a pump (not shown) and via coolant supply and return conduits 108 and 110 in the direction shown by the arrows in FIG. 1. Heat from the heating fluid is provided to increase the enthalpy of the working gas in the first-stage heat exchanger 104. In this way, during operation, the temperature of the working gas can increase while its density decreases as the gas moves from the liquefied state towards a gaseous state.

The working fluid is filtered at a filter 112 after it exits the first-stage heat exchanger 104, and is stored in a high-pressure reservoir or accumulator 114. In typical applications, the amount of heat added to the working fluid by a single heat exchanger would be sufficient to raise the temperature of the working fluid (and also decrease the density of the working fluid) sufficiently to provide fluid that is stored in the accumulator that is immediately useable by an application. However, this means that that the accumulator would need to be sufficiently large to accommodate the fluid at the lower density, and it also means that the temperature of the fluid stored in the accumulator may begin departing from a desired value, especially for prolonged storage periods within the accumulator.

In the illustrated embodiment, the fluid stored under pressure in the accumulator 114 is not yet brought to a useable temperature and density, but is maintained at a higher density to decrease its storage volume and thus the size of the accumulator 114. Moreover, the temperature of the fluid within the accumulator 114 is lower than a useable temperature of the fluid such that, even with prolonged dwell time within the accumulator, the temperature of the gas can increase from ambient heating without exceeding a higher desired useable temperature.

When fluid from the accumulator is required, a selective amount of fluid is drawn from the accumulator 114 through a process supply conduit 116 and into a second-stage heat exchanger 118. The second-stage heat exchanger 118 may have a similar construction to the first-stage heat exchanger 104 such that it imparts thermal energy to the working fluid to elevate its temperature and decrease its density to be within useable ranges. In the illustrated embodiment, the second-stage heat exchanger 118 is connected to the heat source 106 via coolant supply and return lines 120 and 122 such that coolant heated in the heat source 106 can pass through the second-stage heat exchanger 118 to warm the working fluid up to the useable temperature. Working fluid at the useable temperature provided by the second-stage heat exchanger 118 is provided at an outlet port 124 of the gas conditioning system 100. The outlet port 124 may be configured to deliver the working fluid directly to the industrial process in which is it used.

To account for variability in the temperature of the working fluid provided to the second-stage heat exchanger 118 that can result, for example, by variable dwell times of the fluid within the accumulator 114, the system 100 further includes a monitoring and control device 126 disposed to measure parameters indicative of at least the temperature of the working fluid at the outlet of the second-stage heat exchanger 118. The device 126 may be further disposed to monitor signals indicative of the coolant temperature provided to the first- and/or second-stage heat exchangers 104 and 118 from the heat source 106 via appropriate sensors (not shown), as well as to control the flow rate of the coolant used thereby via appropriate valves or other control devices and methods. In addition, the device 126 may regulate the pressure of the working fluid in the system 100 and monitor signals indicative of a change in the supply rate of the working fluid through the system 100 based on requirements of a process disposed to receive the conditioned working fluid at the outlet 124.

By controlling the flow rate of coolant provided at least to the second-stage heat exchanger 118 based on the temperature of the coolant, the desired flow rate of working fluid through the heat exchanger 118, and various heat-transfer constants associated with the system 100, the device 126 can ensure that the working fluid at the outlet 124 can be provided at or close to a desired or operating temperature regardless of other system operating conditions, such as prolonged or insufficient dwell time of the fluid within the accumulator, ambient temperature, and the like. Moreover, such and other functions of the device 126 can be carried out in real time and use closed-loop feedback control systems based on a difference between a desired fluid outlet temperature and an actual or measured fluid temperature at an inlet of the second-stage heat exchanger 118, at the accumulator 114, or at any other appropriate system location. As an added advantage, storage of the working fluid at a depressed temperature within the accumulator 114 enables use of a smaller accumulator when compared to the size of accumulator that would be required to store the working fluid at the useable temperature. Moreover, the heat source 106 may be a device that produces heat for heating the working fluid, or may alternatively be a device that collects waste heat from other industrial processes.

A particular implementation of the system 100 (FIG. 1) in a fuel system for a machine 200 is shown in the block diagram of FIG. 2. The term “machine” may refer to any machine that performs some type of operation associated with an industry such as mining, construction, farming, transportation, marine or any other industry known in the art. For example, the machine 200 may be an earth-moving machine, such as a wheel loader, excavator, dump truck, backhoe, motor-grader, material handler, locomotive, paver or the like. The machine may further include implements (not shown) that may be utilized and employed for a variety of tasks, including, for example, loading, compacting, lifting, brushing, and include, for example, buckets, compactors, forked lifting devices, brushes, grapples, cutters, shears, blades, breakers/hammers, augers, and others.

In the illustrated embodiment, a fuel system 202 of the machine 200 is shown in block-diagram format. The machine 200 includes an engine 204 that may be connected to other structures such as propel and implement systems, generators, and other structures that perform a work task in the known fashion but that are not shown for simplicity. The engine 204 is configured to provide power to drive a liquefied gas pump 206, which in the illustrated embodiment is implemented as a reciprocal piston pump 208 operated by a reciprocal piston motor or actuator 210. The motor 210 includes a plunger 212 that operates a piston 211 of the pump 208. Pressurized hydraulic fluid is successively provided on either side of the plunger 212 via a two-way control valve 214. The hydraulic fluid is drawn from a reservoir 216 and pressurized in a fixed or variable displacement hydraulic pump 218 that is operated by the engine 204. In this way, the plunger 212 of the motor 210 is made to reciprocate within the pump 208.

The reciprocal motion of the piston 211 of the pump 208, in cooperation with two check valves 220, acts as a reciprocating piston pump to draw liquefied gaseous fuel, for example, LNG, from a storage tank 222, where it is cryogenically stored, and pressurize the gaseous fuel to an operating pressure. In the illustrated embodiment, the gaseous fuel is stored at a maximum pressure of about 1.5 MPa and a temperature of about −160 deg. C. within the tank 222. When the LNG is pressurized in the pump 208, its pressure is increased to about 40 MPa.

The pressurized LNG passes from the pump 208 to a first-stage heater 224, where its temperature is increased to about 0 deg. C. and its density is reduced to about 270 kg/m³. In the illustrated embodiment, the first-stage heater 224 is a heat exchanger configured to draw heat from engine coolant to warm the LNG passing therethrough, but other types of coolers using different heat sources can be used. As shown, the first-stage heater 224 is connected via coolant lines 226 and 228 with the engine 204 such that a flow of warm engine coolant can pass through the first-stage heater 224 and provide thermal energy to heat the LNG as it passes through the first-stage heater 224.

The warmed LNG, which is still not at a temperature suitable for use in the engine 204 as a fuel, passes through a filter 230 and is collected in an accumulator 232. As shown, the accumulator 232 has a capacity of about 16.6 Gal. (about 75 Liters). For comparison, it is estimated that a 30 Gal. accumulator would be required to contain about the same mass of fuel but at a higher, normal operating temperature that is suitable for operating an engine. Depending on the operating conditions of the engine 204, natural gas may be drawn from the accumulator 232 during operation. Before LNG from the accumulator 232 can be provided to the engine 204, it is provided to a second-stage heater 234. As shown in FIG. 2, the second-stage heater 234 is connected to the engine 204 via coolant lines 236 and 238, which provide warm engine coolant that can further heat the natural gas up to an operating temperature of about 90 deg. C. and a density of about 197 kg/m³ as the natural gas passes through the second-stage heater 234.

In the embodiment shown, the heating capacity of the second-stage heater 234 may be controlled, for example, by adjusting the flow rate of engine coolant provided to the heater 234 based on the temperature of the engine coolant. More specifically, a flow control valve 240 may be provided in coolant line 238 that is arranged to provide engine coolant to the heater 234. Alternatively, the valve 240 may be provided in the coolant return line 236 to the engine or may be omitted in favor of a dedicated, variable flow coolant pump (not shown) or another flow control device.

Natural gas exiting the second-stage heater 234 is provided to the engine 204 as a gaseous fuel in the known fashion via an engine supply line 242. As shown, the system 200 further includes a pressure regulator device 244 disposed to regulate the pressure of the LNG provided to the engine 204. The pressure regulator device 244 can have any known and suitable construction that operates to control the pressure of the LNG supply to the engine.

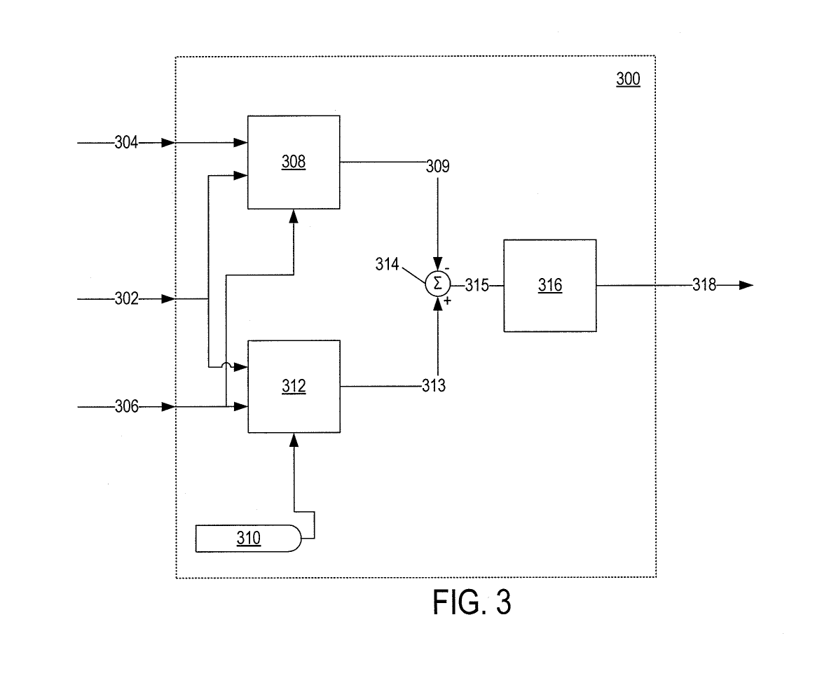

The system 200 further includes various sensors and actuators that communicate with a controller 246 that is configured to regulate operation of the system 200 such that the temperature of the LNG provided to the engine can be controlled more accurately than was possible heretofore. The controller 246, which is embodied here as an electronic controller, may be a single controller or may include more than one controller disposed to control various functions and/or features of a machine. For example, a master controller, used to control the overall operation and function of the machine, may be cooperatively implemented with a motor or engine controller, used to control the engine 204. In this embodiment, the term “controller” is meant to include one, two, or more controllers that may be associated with the machine 200 and that may cooperate in controlling various functions and operations of the machine 200. The functionality of the controller, while described conceptually in FIG. 3 to include various discrete functions for illustrative purposes only, may be implemented in hardware and/or software without regard to the discrete functionality shown. Accordingly, various interfaces of the controller are described relative to components of the system 202 shown in the block diagram of FIG. 2. Such interfaces are not intended to limit the type and number of components that are connected, nor the number of controllers that are described.

In the particular embodiment for the system 202 shown in FIG. 2, the controller 246 is connected with various actuators configured to adjust operation of various components and systems. Accordingly, the controller 246 is connected with a valve actuator 248 associated with the two-way valve 214, and with a pump displacement actuator 250, which adjusts the displacement of the hydraulic pump 218. With these two actuators 248 and 250, the controller may set the LNG pressure and speed of gas pump 208 depending on the fuel requirements of the engine 204, which may be communicated to the controller 246 in any appropriate fashion.

The controller 246 is further configured to receive information indicative of the physical parameters of the natural gas, for example, the pressure and temperature of the natural gas/fluid, at different locations in the system 202, as well as other physical parameters indicative of the operating state of the system 202. It should be appreciated that the liquefied natural gas (LNG) stored in the tank will be transformed to a gaseous phase or a phase approaching a gaseous phase following heating operations. In general, natural gas or any other fluid may be used in the system as applicable.

In the illustrated embodiment, the controller 246 receives state information, which can include pressure and/or temperature of the LNG from a first-stage sensor 252 disposed downstream of the first-stage heater 224 (relative to the flow direction of the natural gas/fluid through the system 202). The parameters measured by sensor 252 are indicative of the heat contribution of the first-stage heater 224 to the LNG, and are also indicative of the physical state of the natural gas/fluid that is stored in the accumulator 232. Optionally, an additional sensor 253 may directly measure gas conditions within the accumulator 232. Along these lines, an optional, additional sensor (not shown) may be placed downstream of the accumulator 232 and upstream of the second-stage heater 234 or, alternatively, the sensor 252 may be placed downstream of the filter 230 and/or downstream of the accumulator 232 anywhere before the inlet to the second-stage heater 234.

When natural gas/fluid is provided to the engine 204, LNG from the first-stage heater 224 and/or from the accumulator 232 is provided to the second-stage heater 234 to complete the heat addition and transform the LNG into gaseous fuel that is useable by the engine 204. The controller 246 is disposed to receive physical parameters relative to fluid present at the outlet of the second-stage heater 234 through a second-stage sensor 254. An additional sensor 256 measuring the temperature of coolant circulating through the second-stage heater 234 provides information about the heat content of the coolant. Based at least on information from the second-stage sensor 254 and the coolant temperature sensor 256, the controller 246 can monitor and control the heat transfer rate of energy into the natural gas/fluid at the second-stage heater 234 by adjusting a position of the coolant valve 240, and/or by other methods. In this way, a desired gaseous fuel temperature at the outlet of the second-stage heater 234 can be achieved.

Based on system information, for example, LNG pressure at various locations in the system, the controller 246 can further control the pressure of the gaseous fuel provided to the engine 204 by appropriate commands provided to the pressure regulator device 244. Given that the temperature and pressure of the gaseous fuel are related, changes in gas temperature that can affect gas pressure can be addressed by appropriate settings of the pressure regulator device 244 that can ensure a constant pressure supply of fuel for the engine 204.

A block diagram for a control system 300 that can be operating within the controller 246 is shown in FIG. 3. Here, the control system 300 is disposed to receive as inputs a first temperature 302 that is indicative of the temperature of the LNG after a first-stage heater as shown, for example, in the system 202 (FIG. 2), which includes a first-stage heater 224; a second temperature 304, which is indicative of the temperature of the natural gas/fluid after a second-stage heater, for example, the second stage heater 234 (FIG. 2); and a flow rate signal 306, which is indicative of the gaseous fuel flow rate that is desired by an engine, for example, the engine 204 (FIG. 2) in real time during operation. As an alternative to receiving the flow rate signal 306, the control system 300 may receive actual, desired or measured values of engine speed and throttle and, based on these parameters, determine a desired flow rate of gaseous fuel into the engine.

These input parameters may be input to an actual heat transfer determination function 308, which based on the temperature increase of the natural gas/fluid through the second-stage heater, the mass flow rate of the natural gas/fluid, and various constants such as the heat capacity of natural gas/fluid, the enthalpy thereof, various efficiency constants of the heater, and other parameters, calculates or determines the actual heat input to the LNG by the second heater, or Q2 309. A desired temperature of the natural gas/fluid, Tdes 310, is provided as a constant or is otherwise determined based on the operating conditions of the engine within the control system 300. The Tdes 310, as well as the flow rate signal 306 and the first temperature 302, are provided to a desired heat transfer determination function 312, which determines a theoretical heat input, Qth 313, that would be required to raise the temperature of the LNG at the desired flow rate to the desired temperature, Tdes, given the then present gas temperature at the flow rate passing through the second-stage heater.

A summing junction 314 calculates a difference between the actual and theoretical heat inputs Q2 309 and Qth 313 to determine a heat input or power difference Qdiff 315. In an alternative embodiment, the difference value could be calculated as a natural gas/fluid temperature difference between an actual/measured and desired temperature. The power difference Qdiff 315 is provided to a control function, for example, a proportional/integral/derivative controller 316, which provides as an output a control signal 318. The control signal 318 is provided to one or more system components or systems operating to increase or decrease the heat transfer to the natural gas/fluid within the second-stage heater such that the outlet temperature of gaseous fuel from the second stage heater is made to approach the desired temperature Tdes as much as possible. In one embodiment, for example, as shown in FIG. 2, the control signal 318 may be provided to the coolant control valve 240 such that, when additional heat input to the natural gas/fluid is required, the control valve may allow a larger flow of warm coolant to pass through the second-stage heater 234. Similarly, when less heat input is desired, i.e., when the gas outlet temperature is too high, the control signal 318 may cause a reduction in the coolant flow rate through the second-stage heater 234. In an alternative embodiment, the control system 300 may operate to calculate a setting for the coolant control valve 240 that represents a desired coolant flow rate through the second-stage cooler based on a calculated heat transfer that depends on the flow rate of gas, the inlet temperature of gas, the desired outlet temperature of gas, the coolant temperature, and various constants.

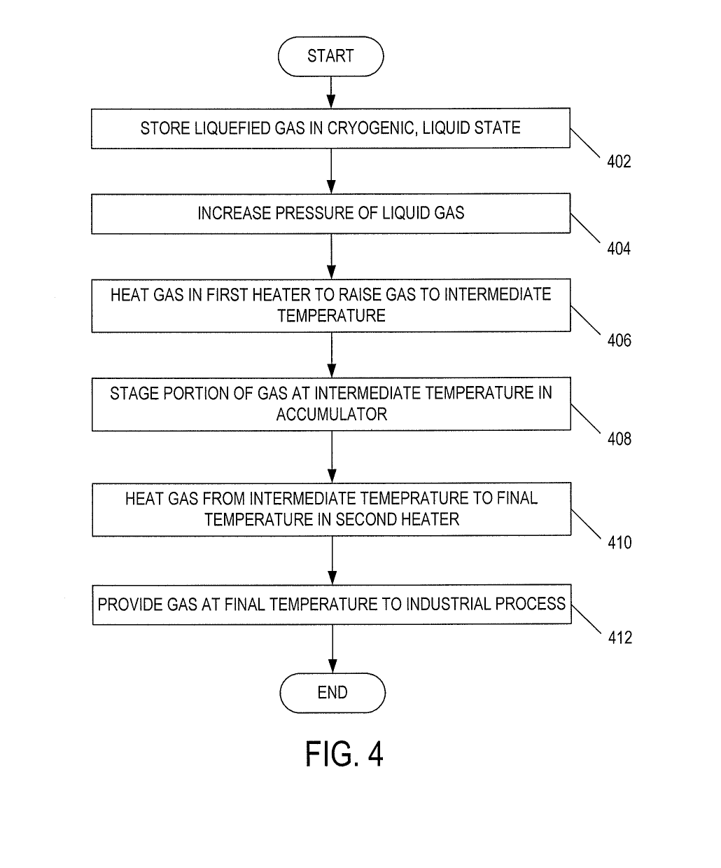

A flowchart for a method of conditioning a liquefied gas is shown in FIG. 4. In the process, the liquefied gas is stored in a cryogenic, liquid state at 402 at a storage or first temperature. The liquefied gas is pumped to a higher pressure at 404. Heat is added in a first heater to raise the temperature of the gas to an intermediate or second temperature at 406. A portion of the gas at the intermediate temperature may be collected in an accumulator at 408. A remaining portion of the gas and/or a portion of the gas collected in the accumulator may be provided to a second heater at 410, which raises the temperature of the gas to a third or final temperature. Gas at the final temperature is useful for and is provided to an industrial process at 412.

### INDUSTRIAL APPLICABILITY

The present disclosure is applicable to systems and methods for conditioning a liquefied gas for use in an industrial process. In one disclosed embodiment, a system, method and control system are disclosed for conditioning a liquefied gaseous fuel, for example, LNG, for use in an internal combustion engine. As is known, liquefied gas such as LNG must be heated to transition from a liquid, cryogenic state to a gaseous state for use in an engine. In typical systems, the heating occurs in a single step, and excess gas from the heating process is stored in an accumulator until required by the engine. In the disclosed systems and methods, the staged heating of the gas allows gas at a lower temperature and, thus a lower volume, to be stored in the accumulator. In this way, a smaller accumulator may be used, which can alleviate packaging considerations when used on-board in a vehicle.

Additionally, the staged heating of the liquefied gas can provide improved control over the delivery temperature of the gas at the outlet of the process. Specifically, the storing of the gas before use can operate to change the temperature of the gas, for example, by the gas being heated or cooled by the environment of the accumulator. By staging the heating of the gas, improved control over the last heating stage before the gas is used can be accomplished, which can account for any changes in temperature that may have occurred for the gas that is stored in the accumulator because of environmental effects.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A conditioning system for a liquefied gas, comprising:
a source of gas in a liquefied state, the gas provided from the source at a first temperature;
a first heater disposed to heat a flow of the gas passing therethrough to a second temperature;
an accumulator disposed to collect and store a quantity of the gas at the second temperature;
a second heater disposed to receive a flow of gas from the accumulator and the first heater, the second heater operating to heat the gas to a third temperature and provide the heated gas at the third temperature to a gas outlet;
wherein the gas at the third temperature is in a gaseous state.

2. The conditioning system of claim 1, further comprising a pressure regulator device for regulating a pressure of the flow of gas provided by the second heater.

3. The conditioning system of claim 1, further comprising a pump for pressurizing the flow of gas from the source to an operating pressure, wherein the pump is disposed upstream of the first heater relative to a direction of flow of the gas from the source to the first heater.

4. The conditioning system of claim 1, further comprising a sensor disposed to measure a temperature of the gas at the outlet of the second heater, and a controller associated with the sensor and disposed to receive a gas temperature signal indicative of the temperature of the gas at the outlet of the second heater from the sensor, the controller operating to adjust a heat input to the flow of gas passing through the second heater such that the temperature of the gas approaches a desired gas temperature.

5. The conditioning system of claim 1, wherein the gas is natural gas that is maintained at the source in a cryogenic state in the form of liquefied natural gas (LNG).

6. The conditioning system of claim 1, wherein the first temperature is about −160 deg. C., the second temperature is about 0 deg. C. and the third temperature is about 90 deg. C.

7. The conditioning system of claim 1, wherein at least one of the first and second heaters is a heat exchanger configured to transfer heat out of a flow of engine coolant circulating therethrough and to transfer heat into the flow of gas passing therethrough.

8. A fuel system for an internal combustion engine associated with a vehicle, the fuel system comprising:
a fuel tank for storing liquefied natural gas (LNG) in a cryogenic state at a first temperature, the fuel tank disposed in the vehicle;
a LNG pump for drawing LNG from the fuel tank and for pressurizing the LNG to an operating pressure;
a first-stage heater disposed to receive LNG from the LNG pump as a fluid flow, the first-stage heater configured to heat the fluid flow to a second temperature by use of heat provided from a first engine coolant flow circulating through the first-stage heater;
an accumulator disposed to receive at least a portion of the fluid flow from the first-stage heater, and to store the portion of the fluid flow therein; and
a second-stage heater disposed to receive at least the remaining portion of the fluid flow from the first heater, the second-stage heater configured to heat the fluid flow to a third temperature by use of heat provided from a second engine coolant flow circulating through the second-stage heater;
wherein the fluid flow at the third temperature is useable as a fuel supply and is provided to the internal combustion engine during operation.

9. The fuel system of claim 8, further comprising a pressure regulator device for regulating a pressure of the fluid flow provided to the internal combustion engine.

10. The fuel system of claim 8, wherein the LNG pump is a reciprocating piston pump operating under power provided by a reciprocatable hydraulic actuator, the hydraulic actuator receiving pressurized hydraulic fluid from a variable displacement hydraulic pump that is operated by the internal combustion engine.

11. The fuel system of claim 8, further comprising respective sensors disposed to measure at least the second and third temperatures, and a controller associated with the sensors, the controller operating to adjust a heat input to the second-stage heater such that the third temperature approaches a desired temperature.

12. The fuel system of claim 8, wherein the first temperature is about −160 deg. C., the second temperature is about 0 deg. C. and the third temperature is about 90 deg. C.

13. The fuel system of claim 8, further comprising a flow control valve disposed to selectively meter the flow of engine coolant provided to the second-stage coolant, the flow control valve being responsive to control signals provided by a controller such that the third temperature approaches a desired temperature of the fluid flow provided to the internal combustion engine.

14. A method for conditioning a liquefied gaseous fuel for use in an internal combustion engine onboard a vehicle, the method comprising:
storing the liquefied gaseous fuel at a first temperature in a cryogenic storage tank carried onboard the vehicle;
drawing a flow of the liquefied gaseous fuel from the cryogenic storage tank, and compressing said flow to an operating pressure;
providing the flow to a first heater that is configured to heat the flow from the first temperature to a second temperature, the second temperature being below an operating temperature for providing gaseous fuel to the internal combustion engine;
storing at least a portion of the flow at least temporarily in an accumulator, the portion of the flow stored at least temporarily being provided to the accumulator close to the second temperature;
providing the flow to a second heater that is configured to heat the flow to a third temperature, the third temperature being about equal to the operating temperature; and
providing the flow at the third temperature to the internal combustion engine.

15. The method of claim 14, further comprising regulating a pressure of the flow while the flow is at the third temperature.

16. The method of claim 14, further comprising measuring at least the third temperature, and adjusting a heat input to the second heater based on a difference between the third temperature and the operating temperature.

17. The method of claim 14, wherein the liquefied gaseous fuel is liquefied natural gas (LNG).

18. The method of claim 1, wherein the first temperature is about −160 deg. C., the second temperature is about 0 deg. C., the third temperature is about 90 deg. C., and the operating temperature is 90 deg. C.

19. The method of claim 1, wherein heating the flow from the first temperature to the second temperature includes passing the flow through a heat exchanger having a first side, through which the flow passes, and a second side, through which a flow of warm engine coolant passes from the internal combustion engine, wherein heat from the warm engine coolant passes to the flow to warm the flow through the first heater.

20. The method of claim 1, wherein heating the flow from the second temperature to the third temperature includes passing the flow through a heat exchanger having a first side, through which the flow passes, and a second side, through which a flow of warm engine coolant passes from the internal combustion engine, wherein the flow of warm engine coolant is adjustable such that heat from the warm engine coolant passes to the flow to selectively warm the flow through the second heater so that the third temperature approaches the operating temperature.
